(19) United States
(12) Patent Application Publication
(10) Pub. No.: US 2016/0267847 A1
(43) Pub. Date: Sep. 15, 2016

(54) DISPLAY DEVICE

(71) Applicant: InnoLux Corporation, Jhu-Nan (TW)

(72) Inventors: Liang-Lu CHEN, Jhu-Nan (TW); Chien-Hsiang HUANG, Jhu-Nan (TW); Ming-Chun TSENG, Jhu-Nan (TW); Chun-Yu CHEN, Jhu-Nan (TW)

(21) Appl. No.: 15/059,996

(22) Filed: Mar. 3, 2016

(30) Foreign Application Priority Data
Mar. 11, 2015 (CN) 201510106044.7

(51) Int. Cl. G09G 3/3283

(52) U.S. Cl. CPC G09G 3/3283; G09G 2300/0861; G09G 2320/0233; G09G 2320/0257

(57) ABSTRACT

A display device comprises a first substrate and a display medium layer. The display medium layer is disposed on the first substrate. The display device has at least a first display unit and a second display unit in a display area. The second display unit is closer to the middle region of the display area than the first display unit, the first display unit and the second display unit with the same display brightness have different current densities, and the current density of the signal for driving the first display unit is smaller than the current density of the signal for driving the second display unit.

### CROSS REFERENCE TO RELATED APPLICATIONS

This Non-provisional application claims priority under 35 U.S.C. §119(a) on Patent Application No(s). 201510106044.7 filed in People's Republic of China on Mar. 11, 2015, the entire contents of which are hereby incorporated by reference

### BACKGROUND

1. Technical Field

The invention relates to a display device, in particular to a display device with less image sticking.

2. Related Art

Because OLED (Organic Light-Emitting Diode) has advantages such as self-luminous, high brightness, high contrast, compact volume, low power consumption and quick response, etc., it is widely applied to various image display system for example OLED display device.

However, if the organic light-emitting display device has operated for a period of time, the decay variations in brightness due to the discrepancy of material degradation of the organic light-emitting elements for different colors usually cause image sticking. Besides, applying different current densities to the organic light-emitting elements affects their lifetime and causes image sticking on the display device. Besides, the display surface of the current organic light-emitting display device is usually rectangular, but future wearable devices or display devices of special shape (e.g. circular) may become popular. Because the pixels in the border portion of the non-rectangular display device are not always rectangular (the pixels near the edge are not complete pixels), the discrepancy between the current density for the pixel near the edge and the current density for the complete pixel within the area causes decay variations in brightness and further causes image sticking.

Therefore, a display device with less image sticking is expected.

### SUMMARY

An aspect of the disclosure is to provide a display device with less image sticking.

A display device comprises a first substrate and a display medium layer. The display medium layer is disposed on the first substrate. The display device includes at least a first display unit and a second display unit in a display area, the second display unit is closer to the middle region of the display area than the first display unit, the first display unit and the second display unit with the same display brightness have different current densities, and the current density of the signal for driving the first display unit is smaller than the current density of the signal for driving the second display unit. That is, when the first display unit and the second display unit display the same display brightness, the first and second display units have different current densities, and the current density of the signal for driving the first display unit is smaller than the current density of the signal for driving the second display unit.

A display device comprises a first substrate and a display medium layer. The display medium layer is disposed on the first substrate. The display device includes at least a first display unit and a second display unit in a display area, the second display unit is closer to the middle region of the display area than the first display unit, and the first display unit and the second display unit with the same display brightness have different current values. That is, when the first display unit and the second display unit display the same display brightness, the first and second display units have different current values.

In one embodiment, the first display unit has substantially the same area size with the second display unit.

In one embodiment, the current density of the signal for driving the first display unit is smaller than the current density of the signal for driving the second display unit.

In one embodiment, the duty cycle of the signal for driving the first display unit is greater than the duty cycle of the signal for driving the second display unit.

In one embodiment, the pattern of the first display unit is an icon.

In one embodiment, the area size of the first display unit is smaller than the area size of the second display unit.

In one embodiment, the current value of the signal for driving the first display unit is smaller than the current value of the signal for driving the second display unit.

In one embodiment, the display area has a plurality of pixels, the second display unit at least corresponds to the area size of one pixel, and the first display unit is near the edge of the display area and at least corresponds to the partial area size of one pixel.

In one embodiment, the area size of the first display unit is larger than the area size of the second display unit, and the current value of the signal for driving the first display unit is greater than the current value of the signal for driving the second display unit

In one embodiment, the duty cycle of the signal for driving the first display unit is smaller than the duty cycle of the signal for driving the second display unit.

In one embodiment, the display area has a plurality of pixels, the second display unit only holds the area size of one pixel, and the first display unit at least corresponds to the area size of one pixel and the partial area size of its another adjacent pixel.

In one embodiment, the shape of the display device is like a circle, an ellipse, or a polygon.

In one embodiment, the shape the display area is defined by a pixel define layer.

In summary, according to embodiments, the display device include at least one first display unit and a second display unit, and the second display unit is closer to the middle region of the display area than the first display unit. The first display unit and the second display unit with the same display brightness have different current densities, and the current density of the signal for driving the first display unit is smaller than the current density of the signal for driving the second display unit; or the first display unit and the second display unit with the same display brightness have different current values.

By adjusting the current density or the current value for the first display unit and the second display unit at different display locations or portions with the same display brightness, light-emitting elements corresponding to the first display unit and the second display unit can have closer lifetime so as to solve the image sticking occurring in the display device.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a sectional schematic diagram showing the display device according to the first embodiment;

FIG. 1B is a front view of the display device in FIG. 1A in one example;

FIG. 2 is a flow chart of the operating process in the mode for decreasing the current density for the display device in one example;

FIG. 3A is a sectional schematic diagram showing the display device according to the second embodiment;

FIG. 3B is a schematic diagram showing the display area of the display device in FIG. 3A;

FIG. 3C is a schematic diagram showing another example of the display device in FIG. 3A; and

FIG. 4A to FIG. 4C are schematic diagrams showing the display area of the display device according to different examples.

### DETAILED DESCRIPTION OF THE INVENTION

The embodiments of the invention will be apparent from the following detailed description, which proceeds with reference to the accompanying drawings, wherein the same references relate to the same elements.

As to OLED elements, the brightness can be expressed by the following formula (1). In the formula, LV indicates the brightness, duty indicates the percentage of the duty cycle (display duty time) of the signal for driving light-emitting element to emit light, η indicates luminous efficiency, and Id indicates the current density (i.e. driving current per unit area) of the signal for driving the light-emitting elements to emit light.

LV=duty×η×Id (1)

To keep the brightness the same for solving image sticking, the current density for 100% duty cycle can be set to a half of the current density for 50% duty cycle. Besides, assuming that the initial brightness of two OLED display panels are set the same, if we observes how the brightness of the panel varies over time, it is found that after the panel is turned on for a period of time, the brightness of the panel operating at 50% duty cycle decays faster than that at 100% duty cycle (the reason is that the operating currents for the two panels do not decay over time, namely, the OLED material of the panel operating at 50% duty cycle decays faster). Besides, as the current density is larger, the lifetime of the organic light-emitting elements is shorter so the image sticking may occur. Therefore, by controlling the current densities (or currents) for different display portions (or locations) on demand, the patterns displayed in different portions of the panel with the same display brightness have closer lifetime so as to solve image sticking.

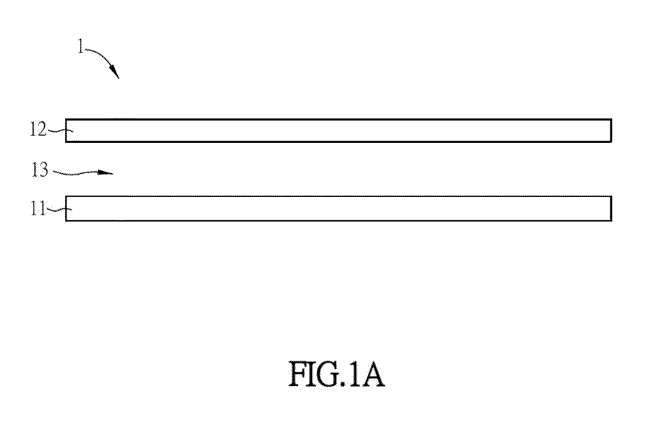

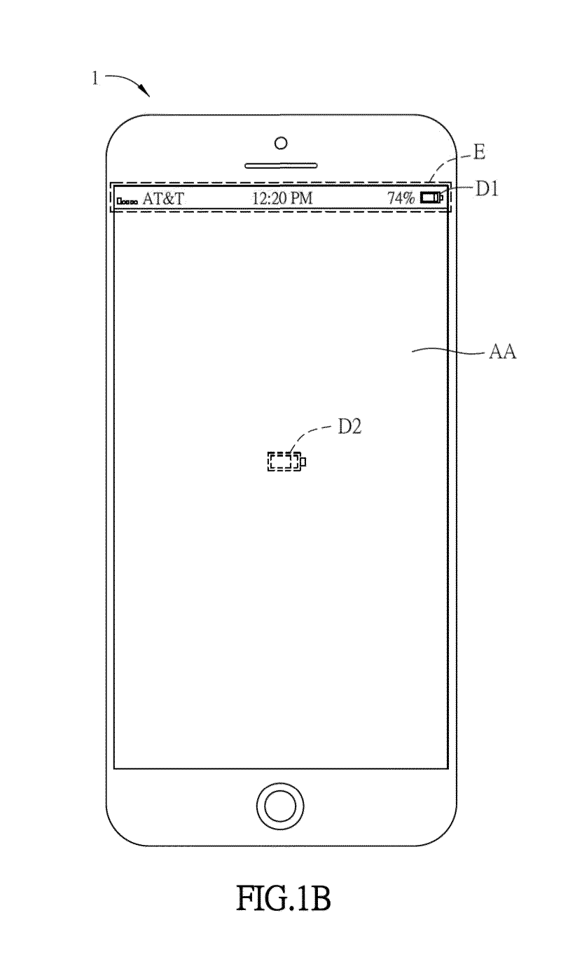

Referring to FIG. 1A and FIG. 1B, FIG. 1A is a sectional schematic diagram showing the display device 1 according to the first embodiment. FIG. 1B is a front view of the display device in FIG. 1A in one example. Here, the display device 1 is an OLED display device and it is a mobile phone for example.

Referring to FIG. 1A, the display device 1 comprises a first substrate 11, a second substrate 12 and a display medium layer 13. The first substrate 11 and the second substrate 12 are disposed opposite each other. The display medium layer 13 is disposed between the first substrate 11 and the second substrate 12. The material of the first substrate 11 or the second substrate 12 may be transparent material, for example glass, quartz or the like, plastic, rubber, glass fiber or other polymer materials. In the embodiment, the material of the first substrate 11 and the second substrate 12 are glass for example. Moreover, the display medium layer 13 is an OLED layer, and the display device 1 is an OLED display device. In one embodiment, if the OLED layer emits white light, the first substrate 11 may be a TFT (Thin Film Transistor) substrate and the second substrate 12 may be a color filter substrate. In another embodiment, if the OLED layer emits for example red, green or blue lights, the first substrate 11 may be a TFT substrate and the second substrate 12 may be a cover plate to protect the OLED layer from external moisture or impurity.

As shown in FIG. 1B, the display device 1 has a display area AA. Here, the display area AA is defined as the region for displaying image on the screen of the display device 1. The display device 1 includes at least a first display unit D1 and a second display unit D2 in the display area AA. Display units (D1, D2) may be called the display zone which may represent the pattern such as an icon (or text, figure, line, numeral, symbol, or any combination thereof) shown on the display screen. In other words, the first display unit D1 or the second display unit D2 represents the pattern which is displayed by at least one pixel.

The second display unit D2 is closer to the middle region of the display area AA of the display device 1 than the first display unit Dl. It means that with respect to the first display unit D1, the second display unit D2 is closer to the middle region of the display area AA (i.e. the first display unit D1 is closer to the edge of the display area AA), but it does not mean that second display unit D2 must be only displayed at the middle region of the display area AA. In the embodiment, the second display unit D2 is located at the middle of the display area AA, and the first display unit D1 is near the upper edge of the display area AA. The first display unit D1 and the second display unit D2 with the same display brightness have different current densities.

The first display unit D1 is a normally displayed icon. Here, the “normally displayed icon” means that the icon is continuously displayed on the display area AA for a period of time under the normal operation of the display device 1 (except shutdown or sleep), and it does not disappear when the display device 1 executes an app (application program). For example, it is displayed at a certain designate zone in the display area AA (the designate zone may be called an information bar, for example the edge E of the display area AA) as soon as the device is turned on. For example, the first display unit D1 may be a battery pattern (indicating state of charge), a WIFI symbol, an antenna symbol, a “%” symbol, a “HOME” button symbol, or a numeral, band, symbol or pattern indicating a certain characteristic or function (e.g, time) of the wearable device, but it is not limited thereto. For example, the first display unit D1 in the embodiment displays a battery icon (battery pattern) indicating the state of charge (alternatively or in addition to the battery pattern in FIG. 1B, a numeral for indicating time, etc.). Moreover, in comparison with the first display unit D1, the second display unit D2 is not the normally displayed pattern and it can be a virtual pattern. Moreover, in one embodiment, the first display unit D1 substantially has the same area size with the second display unit D2 (i.e. respectively have the same quantity of corresponding pixels).

Thus, in comparison with the second display unit D2 in the display device 1, the first display unit D1 displays an unchanged pattern (icon) during most operation period. Therefore, in the embodiment, under the condition that the display brightness of the first display unit D1 for this designate zone (maybe more than one, the quantity depends on whether the displayed pattern is an unchanged pattern) keeps the same as the display brightness of the second display unit D2, the first display unit D1 and the second display unit D2 are configured to have different current densities Id. For example, to let the brightness of the first display unit D1 and the second display unit D2 be equal, the current density Id of the signal for driving the first display unit D1 is controlled to be smaller than the current density Id of the signal for driving the second display unit D2. Thus, the lifetime of the pixels corresponding to the first display unit D1 are extended and the image sticking occurring in this zone in the display device 1 is solved (because the OLED material decays faster as the current density Id is higher, decreasing the current density Id can prolong lifetime of the OLED elements in the corresponding zone of the first display unit D1).

Moreover, because the brightness of the two units needs to be maintained, the duty cycle of the signal for driving the first display unit D1 can be controlled to be larger than the duty cycle of the signal for driving the second display unit D2 to keep the first display unit D1 having the same display brightness with the second display unit D2 to solve image sticking if the current density Id of the signal for the first display unit D1 is smaller than the current density Id of the signal for the second display unit D2.

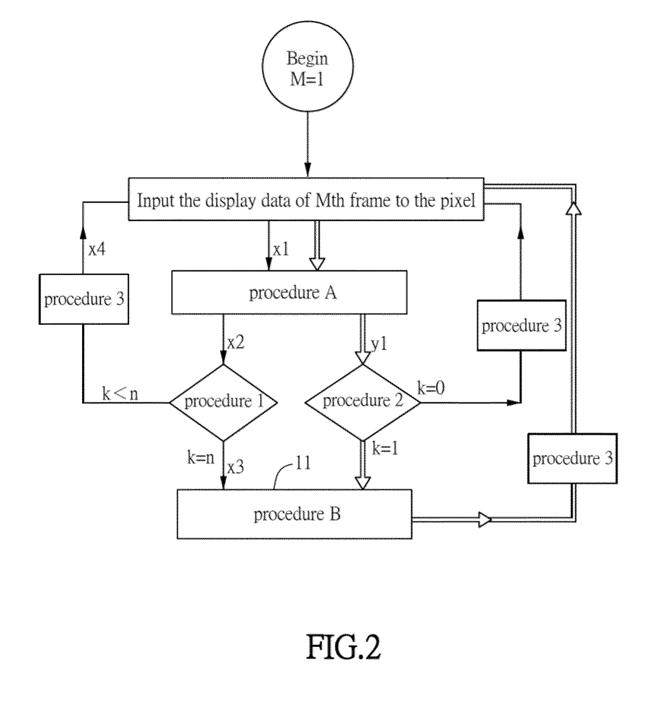

Referring to FIG. 2, it is a flow chart of the operating process in the mode for decreasing the current density for the display device in one example. The figure illustrates determining whether the first display unit D1 is the normally displayed pattern for operation in the mode for decreasing the current density Id. This process counts the number of times that the pixel is turned on, and accordingly determines whether to decrease the current density or not.

At beginning, set M (the frame) to 1, and then input the display data of the 1st frame to these pixels of the display device to display image. Then, enter the procedure A along the arrow x1: to add 1 to value k for the turn-on pixel (for example the pixel currently displaying image), and to remain the value k for the turn-off pixel (for example the pixel currently not displaying image) unchanged (0); then enter the procedure 1 along the arrow x2. As to the arrow x3, if the value k for the pixel is equal to n (n is a default threshold, but it still can be changed or set by the user. For example, if n=10, it indicates that the pixel has displayed 10 frames, and it also means that the pixel is normally displayed), enter the procedure B: to change the display mode of the pixel of which the value k is equal to n into the mode for decreasing the current density and reset k to 0.

Moreover, in the procedure 1, if the value k is smaller than n, enter the procedure 3: not to change or to keep the display modes for these pixels; then, along the arrow x4 to input the display data of the next frame (e.g. M=2) to these pixels of the display device to display image. Then, enter the procedure A again.

Furthermore, subsequent to the procedure B, enter the procedure 3: not to change or to keep the display modes for these pixels. Then, input the display data of the next frame (for example M=2) to these pixels of the display device to display image. Then, repeatedly enter the procedure A: to add 1 to the value k for the turn-on pixel (for example the pixel currently displaying image), and to remain the value k for the turn-off pixel (for example the pixel currently not displaying image) unchanged (0); then enter the procedure 2 along the arrow y1: to check the value k for every pixel. If the value k is equal to 0, then enter the procedure 3: not to change or to keep the display mode; if the value k is equal to 1, enter the procedure B, and so on.

Moreover, in the procedure B, after changing the display mode for these pixels of which the value k is equal to n to the mode for decreasing the current density (reset the value k to 0), enter the procedure 3: not to change or to keep the display mode (here, the display mode for these pixels of which the value k is equal to n has been changed to the mode for decreasing the current density). Then, enter the procedure A again and then enter the procedure 2 instead of the procedure 1, and enter the procedure 3 to the procedure 1 again until the procedure 2 finds that the value k for the pixel is equal to 0.

Thus, the above procedure process checks each pixel of the display device whether the display time of the pixel over frames is long enough. If the display time exceeds the threshold n, the pixel is determined to belong to the first display unit D1 for normally displaying, and the corresponding pixels are controlled to operate in the mode for decreasing the current density.

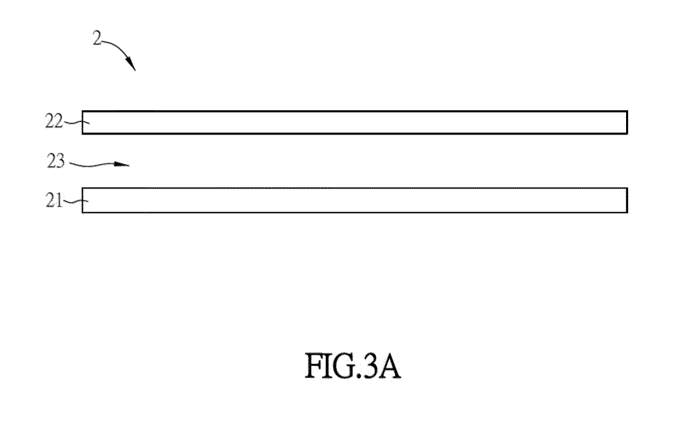

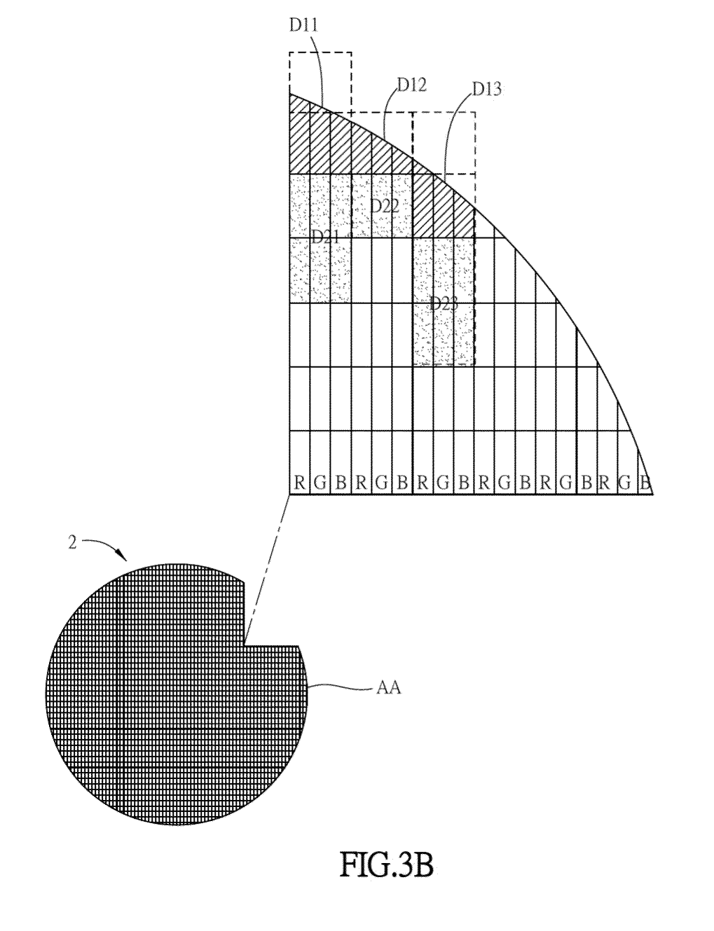

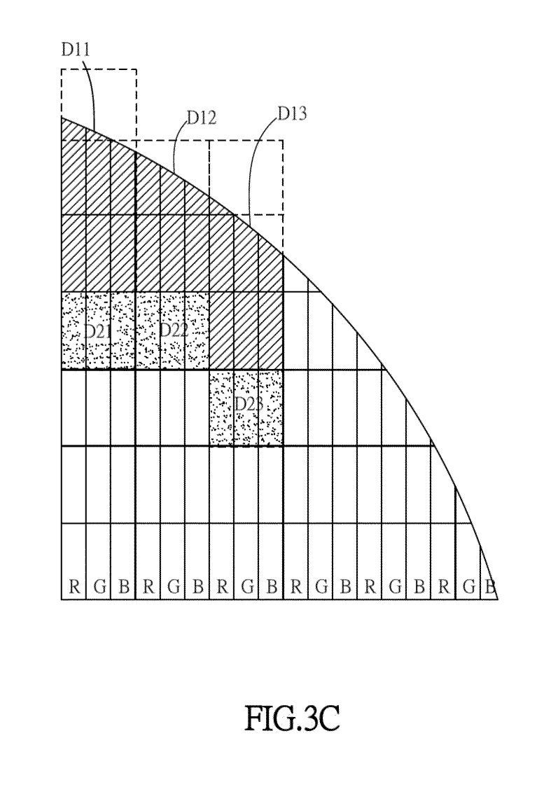

Referring to FIG. 3A and FIG. 3B, FIG. 3A is a sectional schematic diagram showing the display device 2 according to the second embodiment. FIG. 3B is a schematic diagram showing the display area AA of the display device 2 in FIG. 3A.

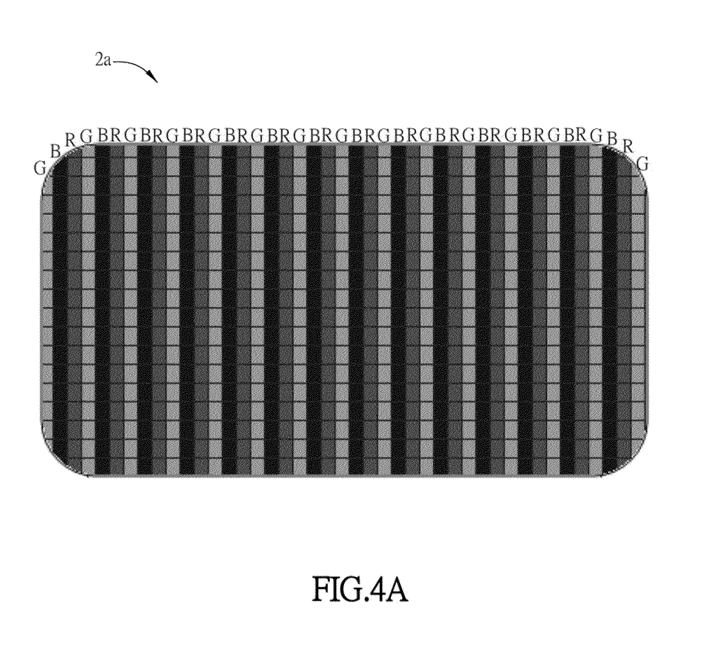

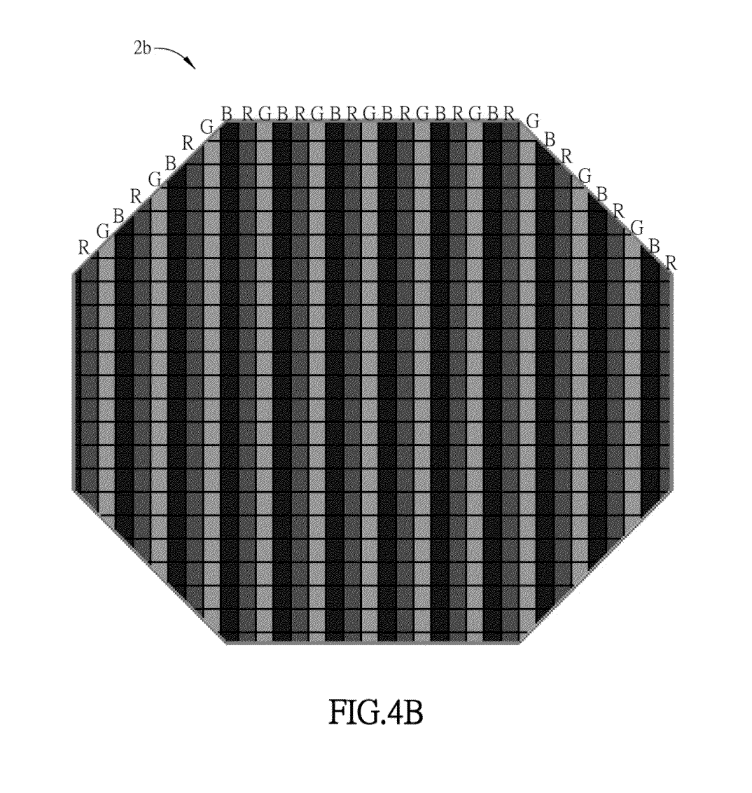

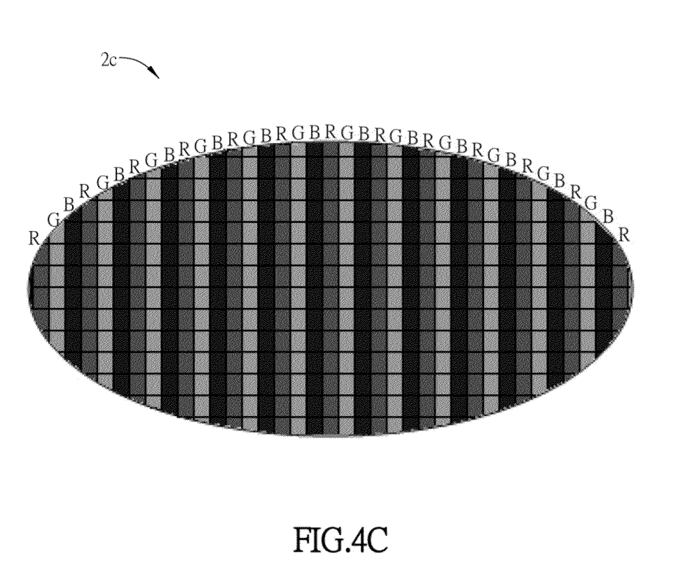

Here, the display device 2 is an OLED display device. In addition, the display area AA of the display device 2 is not rectangular (for example circular). As to the non-rectangular display area AA, the contour of the edge of the display area AA can be defined by patterning a pixel define layer (insulation layer) in OLED technique so as to define the shape of the display area AA for a special outline of the display device. In other embodiment, for example FIG. 4A to FIG. 4C, the shape of the display area of the display devices 2a, 2b, 2c may be like an ellipse, a polygon or other non-rectangular shapes. Thus, the border portion of the display area holds the area size of at least one incomplete pixel.

In FIG. 3B, R (red), G (green), B (blue) are regularly arranged and repeat to form the display area AA (from top to bottom, a whole strip of the sub-pixels are the same color, three sub-pixels of different colors form one pixel). However, in other embodiment, the display area AA may be composed of four colors which are also regularly arranged and repeat, but it is not limited thereto. Because the display area AA of the display device 2 is not rectangular, there are several non-rectangular portions near the edge, which are also called the border pixels (incomplete pixels or sub-pixels) of the display area AA in FIG. 3B. In FIG. 3B, three complete rectangular portions are regarded as one complete pixel.

Because there are several border pixels (incomplete pixels) which are not rectangular near the edge of the display area AA in FIG. 3B, the area size of the pixel near the edge is smaller than that of the complete pixel. Accordingly, provided with equivalent driving current, the current density of the border pixels will be greater than that of the complete pixels. Similarly, the adjustment with the current density and/or the duty cycle previously mentioned can be utilized to let the brightness of the border pixel and the complete pixel be closer so as to solve image sticking in the display device 2.

Referring to FIG. 3A again, the display device 2 comprises a first substrate 21, a second substrate 22 and the display medium layer 23. The first substrate 21 and the second substrate 22 are disposed opposite. The display medium layer 23 is disposed between the first substrate 21 and the second substrate 22. As shown in FIG. 3B, the display area AA of the display device 2 correspond to multiple pixels. Here, the display area AA is defined as the region for displaying image on the screen of the display device 2, and it is a circular image display portion for example. The display device 2 in the display area AA includes at least a first display unit and a second display unit. The first display unit is located near the edge of the display area AA and at least corresponds to the partial area size of one pixel (complete pixel) (the partial area size of the pixel means that one portion of the complete pixel is cut off, the residual portion is called the border pixel), and the second display unit at least corresponds to the area size of one (complete) pixel.

The second display unit is closer to the middle region of the display area AA of the display device 2 than the first display unit. Here, it means that the first display unit is located at the edge of the display area AA, and the second display unit is closer to the middle region of the display area AA, but it does not mean that the second display unit must only be displayed at the middle region of the display area AA. If the border pixel lacks one sub-pixel of R, G or B (i.e. incomplete sub-pixel), this border pixel as well as the adjacent complete pixel having three colors can be applied with a combinative adjustment of the current density and/or the lighting period (i.e. the duty cycle).

For example, as to the first display unit D11 in FIG. 3B, R, G, B in the upper portion are not complete sub-pixels and the B sub-pixel is also incomplete in the lower portion, so the first display unit D11 holds the partial area sizes of the two pixels, and the second display unit D21 represents the two complete pixels which are adjacent to (below) the first display unit D11 (but the area size of the first display unit D11 is smaller than the area size of the second display unit D21). Besides, regarding to the first display D12, R, G, B in only one pixel are not complete sub-pixels, so the first display unit D12 only holds the partial area size of one pixel, and the second display unit D22 represents a complete pixel which is adjacent to the first display unit D12 (the area size of the first display unit D12 is smaller than the area size of the second display unit D22). Moreover, regarding the first display unit D13, R, G, B in the upper portion are not complete sub-pixels and the sub-pixels G, B are also incomplete in the lower portion, so the first display unit D13 also holds the partial area sizes of two pixels and the second display unit D23 represents the two complete pixels which are adjacent to (below) the first display unit D13 (the area size of the first display unit D13 is also smaller than the area size of the second display unit D23), and so on.

In the embodiment, by adjusting the current density and/or the lighting period for the first display unit D11 and the second display unit D21, the first display unit D12 and the second display unit D22, the first display unit D13 and the second display unit D23 . . . , the border pixel and the complete pixel in the display area have closer lifetime to solve the image sticking occurring in the display device 2.

According to the formula (1) mentioned above, to obtain the same brightness, if the first display unit has smaller area size than the second display unit, its current density Id will become larger correspondingly. Thus, to keep the same current density Id, there may be a need to decrease the current proportionally (accordingly, there may be a need to increase the duty cycle). The adjusted current value for the first display unit can be expressed by the formula (2), and the adjusted duty cycle (lighting period) for the first display unit can be expressed by the formula (3). I_{ADJ} is the adjusted current value for the first display unit, I_{O} is the current value for the second display unit, and the area percentage is equal to the percentage that the first display unit is divided by the second display unit, and Duty_{ADJ} is the adjusted duty cycle for the first display unit.

I_{ADJ}=I_{O}×area percentage (2)

Duty_{ADJ}=1/area percentage (3)

For example, because the first display units D11, D12, D13 and the second display units D21, D22, D23 previously mentioned have different area sizes, there may be a need to have different current values for these units to keep the same brightness. In the embodiment, the area size of the first display units D11, D12, D13 is smaller than the area size of the second display units D21, D22, D23 (the area percentage between the two can be computed). Thus, the current value of the signal for driving the first display unit can be controlled to be proportionally smaller than the current value of the signal for driving the second display unit. Similarly, the duty cycle of the signal for driving the first display unit can be controlled to be proportionally greater than the duty cycle of the signal for driving the second display unit to keep the display brightness of the first display units D11, D12, D13 and the second display units D21, D22, D23 the same respectively. Accordingly, the border pixel (the first display unit) and the rectangular pixel in the display area (the second display unit) have closer lifetime so as to solve the image sticking occurring in the display device 2. Moreover, by the above modulation manner, the color shift occurring in the border pixels can also be prevented, and the edge of the display area AA looks smoother.

As to implementation, an IC is utilized with the formula (2) to compute the current value to which the new grayscale for each first display unit corresponds so as to proportionally decrease the current value to drive the corresponding first display unit. Besides, the IC may be utilized with the formula (3) to compute the new lighting period (the duty cycle) for each first display unit. The first display units can be divided into several different groups depending on their area sizes for different duty cycles. Thus, the duty cycle can be correspondingly and proportionally raised to drive the corresponding first display unit. Therefore, the traces and the pins of IC can be reduced.

Moreover, referring to FIG. 3C, it is a schematic diagram showing another example of the display device 2 in FIG. 3A.

The devices in FIG. 3C and FIG. 3B have the same shapes. The difference is that the definition of the first display unit and the second display unit in FIG. 3C is different from that in FIG. 3B. Here, the first display unit at least corresponds to the area size of one pixel and the partial area size of its adjacent pixel, and the second display unit only contains the area size of one complete pixel. In other words, the incomplete pixel near the edge of the display area AA together with its adjacent complete pixel can be regarded as a first display unit. For example, regarding the first display unit D11 in FIG. 3C, R, G, B in the upper portion are not complete sub-pixels and the B sub-pixel is also incomplete in the lower portion, so in addition to the partial area sizes of these two pixels, the first display unit D11 further holds another adjacent (below) complete pixel, and the second display unit D21 represents one complete pixel which is adjacent to (below) the first display unit D11 (the area size of the first display unit D11 is greater than the area size of the second display unit D21). Besides, regarding the first display unit D12, R, G, B in only one pixel are not complete sub-pixels, so in addition to the partial area size of one pixel, the first display unit D12 further holds another one adjacent (below) complete pixel, and the second display unit D22 represents one complete pixel which is adjacent to (below) the first display unit D12 (the area size of the first display unit D12 is also greater than the area size of the second display unit D22). Moreover, regarding the first display unit D13, R, G, B in the upper portion are not complete sub-pixels and the G, B sub-pixels are also incomplete in the lower portion, so in addition to the partial area sizes of these two pixels, the first display unit D13 further holds another one adjacent (below) complete pixel, and the second display unit D23 represents one complete pixel which is adjacent to (below) the first display unit D13 (the area size of the first display unit D13 is greater than the area size of the second display unit D23), and so on.

In the embodiment, by adjusting the current density and/or the lighting period for the first display unit D11 and the second display unit D21, the first display unit D12 and the second display unit D22, the first display unit D13 and the second display unit D23 . . . , the border pixel and the complete pixel in the display area have closer lifetime to solve the image sticking occurring in the display device 2.

According to the formula (1), to obtain the same the brightness, if the first display unit has greater area size than the second display unit, its current density Id will become smaller correspondingly. Thus, to keep the same current density Id, there may be a need to increase the current proportionally (there may be a need to decrease the duty cycle proportionally accordingly). The adjusted current value for the first display unit can be expressed by the formula (2), and the adjusted duty cycle (the lighting period) for the first display unit can be expressed by the formula (3), and they are not repeated again here.

For example, because the first display units D11, D12, D13 and the second display units D21, D22, D23 have different area sizes, there may be a need to have different current values for these units to keep the same brightness. In the embodiment, the area size of the first display units D11, D12, D13 is greater than the area size of the second display unit D21, D22, D23 (the area percentage between the two may be computed). Thus, the current value of the signal for driving the first display unit can be controlled to be greater than the current value of the signal for driving the second display unit, so the first display unit and the second display unit have the same current density Id. Similarly, the duty cycle of the signal for driving the first display unit can be controlled to be smaller than the duty cycle of the signal for driving the second display unit to keep the display brightness of the first display units D11, D12, D13 and the second display units D21, D22, D23 the same. Accordingly, the border (the first display unit) and the rectangular pixel in the display area (the second display unit) have closer lifetime so as to solve the image sticking occurring in the display device 2. In addition, in comparison with the manner in FIG. 3B, the above modulation manner, which raises the current for the border pixel and decreases the lighting period, has another result of a flexible or wider modulation range due to the reduction of the lighting period for the border pixel, and it is not necessary to decrease the lighting period for the complete pixel in the display area due to the adjustment for the border pixel.

Moreover, in addition to the circular display area in the above-mentioned embodiments, the modulation manners mentioned above may be applied to other display devices with different outlines (for example vehicle display device or the display device for aircraft cabin or other display device with special mechanism or design) to solve the image sticking occurring in the display device with special outline due to discrepancy in the lifetime of the border pixel and the complete pixel in the display area.

In summary, according to embodiments, the display device includes at least one first display unit and a second display unit, and the second display unit is closer to the middle region of the display area than the first display unit. The first display unit and the second display unit with the same display brightness have different current densities, and the current density of the signal for driving the first display unit is smaller than the current density of the signal for driving the second display unit; or the first display unit and the second display unit with the same display brightness have different current values. By adjusting the current density or the current value for the first display unit and the second display unit at different display locations or portions with the same display brightness, light-emitting elements corresponding to the first display unit and the second display unit can have closer lifetime so as to solve the image sticking occurring in the display device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a first substrate; and
a display medium layer disposed on the first substrate,
wherein, the display device includes at least a first display unit and a second display unit in a display area, the second display unit is closer to the middle region of the display area than the first display unit, the first display unit and the second display unit with the same display brightness have different current densities, and the current density of the signal for driving the first display unit is smaller than the current density of the signal for driving the second display unit.

2. The display device of claim 1, wherein the first display unit has substantially the same area size with the second display unit.

3. The display device of claim 1, wherein the duty cycle of the signal for driving the first display unit is greater than the duty cycle of the signal for driving the second display unit.

4. The display device of claim 1, wherein the pattern of the first display unit is an icon.

5. A display device, comprising:
a first substrate; and
a display medium layer disposed on the first substrate,
wherein, the display device includes at least a first display unit and a second display unit in a display area, the second display unit is closer to the middle region of the display area than the first display unit, and the first display unit and the second display unit with the same display brightness have different current values.

6. The display device of claim 5, wherein the area size of the first display unit is smaller than the area size of the second display unit.

7. The display device of claim 5, wherein the current value of the signal for driving the first display unit is smaller than the current value of the signal for driving the second display unit.

8. The display device of claim 7, wherein the duty cycle of the signal for driving the first display unit is greater than the duty cycle of the signal for driving the second display unit.

9. The display device of claim 5, wherein the area size of the first display unit is larger than the area size of the second display unit, and the current value of the signal for driving the first display unit is greater than the current value of the signal for driving the second display unit.
